(19) United States
(12) Patent Application Publication
(10) Pub. No.: US 2007/0177680 A1
(43) Pub. Date: Aug. 2, 2007

(54) Emulating system, apparatus, and method for emulating a radio channel

(76) Inventors: Marilynn P. Green, Pomona, NY (US); Shu-Shaw Wang, Arlington, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/562,863

(22) PCT Filed: Jun. 30, 2004
(86) PCT No.: PCT/US04/21261

§ 371 Date: Jul. 13, 2006

Related U.S. Application Data
(60) Provisional application No. 60/483,662, filed on Jun. 30, 2003.

(51) Int. Cl. H04K 1/10

(52) U.S. Cl. 375/260

(57) ABSTRACT

Apparatus, and an associated method, for modeling a channel impulse response of a radio channel. The model emulates an actual radio channel and is formed of non-diffuse as well as diffuse components. The model is used, for example, to test mobile stations for their compliance with E-911 phase II mandates.

### FIELD OF THE INVENTION

The present invention relates generally to a manner by which to emulate, or otherwise model, a communication channel, such as a radio channel upon which signals are sent during operation of a cellular, or other, radio communication system. More particularly, the present invention relates to apparatus, and an associated method, by which to estimate a channel upon which the signals are sent, better taking into account site-specific characteristics.

The channel estimate is used, e.g., to test performance of a cellular mobile station to determine its location pursuant to advanced forward link trilateration (AFLT) procedures. Because the channel estimate better takes into account the site-specific characteristics, the channel estimate is more accurate than channel estimates that are formed using conventional techniques.

### BACKGROUND OF THE INVENTION

Without limiting the scope of the invention, its background is described in connection with emulator test systems used to model signal response over communication channels.

Advanced forward link trilateration (AFLT) is a handset-based geolocation technology that has been standardized for the emergency location of CDMA terminals by the Telecommunications Industry Association's TR45.5 in IS-801. In order to provide the appropriate measurements for AFLT-based positioning, the mobile device must measure the time differences between CDMA pilot signals, where the term CDMA pilot signals specifically refers to the serving cell pilot signal and neighboring cell pilot signals (see FIG. 1). The observations from two such neighboring cells along with the serving base station’ coordinates are minimally sufficient to determine the location of the mobile device (although, in practice, more pilot signals may be captured in order to reduce the final location error). In the AFLT implementation, the terminal uses IS-801 standardized messaging to convey the measurement data to the PDE (Position Determination Element) by way of the CDMA network. Finally, at the PDE, the measured time (phase) differences can be converted to range differences that can be used to formulate a simultaneous system of nonlinear equations. In the absence of any measurement or systematic error, the intersection of these equations unambiguously defines the handset's location.

The FCC has defined a set of accuracy requirements for E-911 calls, which are collectively known in the industry as the E-911 Phase II mandate. The mandate states that handset-based solutions should locate the E-911 caller to within 50 meters for 67% of the calls and to within 150 meters for 95% of the calls. The new ALI (Automatic Location Identification)-capable handsets must fulfill the FCC's E-911 Phase II location accuracy requirement by October 2003.

FCC OET Bulletin No. 71 defines a statistical approach for demonstrating compliance for empirical testing. If n denotes the number of measurements, the r^{th} and s^{th} measurements are denoted as xᵣ and yₛ respectively x and y are the percentile points associated with probabilities p₁ and P₂ respectively, then the probability that x is less than xᵣ while simultaneously y is less than yₛ is given by the formula:

$$confidence ( x \leq {x}_{r} , y \leq {y}_{s} ; n , r , s , {p}_{1} , {p}_{2} ) = {\sum }_{i = 1}^{r - 1} {\sum }_{j = i}^{s - 1} ( \begin{matrix}n \\ i\end{matrix} ) ( \begin{matrix}n - i \\ n - j\end{matrix} ) {{p}_{1}^{i} ( {p}_{2} - {p}_{1} )}^{j - i} {( 1 - {p}_{2} )}^{n - j}$$

p₁=0.67 and P_{2=0.95}. This formula is used in order to verify compliance.

This mandate has a tremendous impact on the carriers as well as the vendors, so it is rather important to establish reproducible and non-discriminatory test scenarios, testing methods and procedures in order to verify that the mobile phones fulfill these and possibly other accuracy requirements. As is the case with mobile phone compliance and verification testing, the carriers/vendors also need a standardized test environment in which location system calibration and verification can be performed. Therefore, a standardized laboratory test system, which can be used in lieu of extensive field-testing, can be used as a basis to verify the location accuracy for different brands of the phones in different (emulated) environments—and this type of system is currently in great demand. In addition, laboratory testing may also reduce the number and cost of field trials.

Prior to widescale deployment of AFLT, handset manufacturers and infrastructure vendors require a standardized, well-defined and repeatable method for testing system-integrated performance in a real-time re-configurable test system. This intermediate stage of testing may, in fact, circumvent the need to schedule field tests at all but a nominal number of live test sites prior to implementation. At least two of the major test equipment vendors have already developed E911 Phase II compliance verification system that could be used for testing the A-FLT location technology. The current approach is to use state-of-the-art CDMA network emulation hardware with programmable impairments in order to model some of the real-world cellular network phenomena that degrade system performance. They also use purely stochastic radio channel modeling that is either based on channel models that are obtained directly from the literature or from those published by the standards bodies for the compliance testing of mobile devices. While these models may capture some of the important aspects of the radio channel for different multipath environment (such as urban, rural and suburban), they cannot closely model the channel impulse response that will be encountered in a particular location. Thus, although a rural channel model may give some indication of the average channel properties for an area that falls into this classification, one might find that the actual deviations of the true radio channel from the stochastic channel model in a particular rural area might indeed be significant. Hence, it is readily apparent that the E911 Phase II compliance and verification systems that have been designed are not customized to predict the location accuracy for specific geographical areas.

In order to produce a standardized commercial hardware-in-the-loop test system that can be used by different manufacturers to test for E-911 Phase II compliance under realistic conditions, there is a need to develop more sophisticated radio channel models than those that are currently available. The test system should be constructed in such a way that it can emulate—with a sufficient level of detail—the integrated effects that the cellular system, the mobile terminal and the environment have on the final geo-location accuracy. Since the technology that is required to emulate cellular system and mobile terminal performance is readily available, we believe that there is an opportunity to create a new procedure for radio channel modeling that will allow us to better emulate some of the real-life E-911 scenarios that may occur in rural, sub-urban, urban and highway types of environments. While the existing empirically based stochastic channel models may be adequate to represent the average propagation characteristics over a range of broadly defined environments, they are simply inadequate to replicate the idiosynchrasies of the radio channel in any specific locale. Hence, a generic “downtown urban” propagation model would never fully capture the differences between downtown Chicago and downtown Dallas, since they would both belong to the same multipath category and would therefore be described by the same average channel parameters. Thus, we have the motivation to develop channel models that are more site-specific and therefore closer to the results that would be obtained from actual field-testing.

As may be seen, an improved method and system to model the effects a surrounding environment has on radio transmissions could provide an improved emulation device for more accurately predicting location accuracy.

What is needed, therefore, is an improved manner by which to model, or otherwise emulate, a communication channel upon which signals are sent.

It is in light of this background information related to channel estimation of channels upon which signals are sent that the significant improvements of the present invention have evolved.

### SUMMARY OF THE INVENTION

The present invention, accordingly, advantageously provides apparatus, and an associated method, by which to emulate, or otherwise model, a communication channel, such as a radio channel upon which signals are sent during operation of a cellular, or other, radio communication system.

Through operation of an embodiment of the present invention, a manner is provided by which to estimate a channel upon which the signals are sent. The channel estimate better takes into account site-specific channel characteristics. And, an improved method and system for determining the channel response of a communication channel for a particular geographic area is presented.

In one aspect of the present invention, the channel estimate is used to test the performance of a cellular mobile station when determining its location pursuant to advanced forward link trialateration procedures. As the channel estimate better takes into account the site-specific characteristics of the radio channel defined, in part, by the location at which the cellular mobile station is positioned, the channel estimate is more accurate than channel estimates that are formed using conventional channel estimation techniques.

The present invention presents an improved method and system for determining the channel response of a communication channel for a particular geographic area.

In order to produce a standardized commercial hardware-in-the-loop test system that can be used by different manufacturers to test for E-911 Phase II compliance under realistic conditions, there is a need to develop more sophisticated radio channel models than those that are currently available. The test system should be constructed in such a way that it can emulate—with a sufficient level of detail—the integrated effects that the cellular system, the mobile terminal, and the propagation environment have on the final geo-location accuracy. Since the technology that is required to emulate cellular system and mobile terminal performance is readily available, we believe that there is an opportunity to create a new procedure for radio channel modeling that will allow us to better emulate some of the real-life E-911 scenarios that may occur in rural, sub-urban, urban and highway types of environments. While the existing empirically based stochastic channel models may be adequate to represent the average propagation characteristics over a range of broadly defined environments, they are simply inadequate to replicate the idiosyncrasies of the radio channel in any specific locale. Hence, a generic “downtown urban” propagation model would never fully capture the differences between downtown Chicago and downtown Dallas, since they would both belong to the same multipath category and would therefore be described by the same average channel parameters. Thus, we have the motivation to develop channel models that are more site-specific and therefore closer to the results that would be obtained from actual field-testing. One method for generating site-specific channel models is through the use of ray tracing, by which one can simulate the behavior of RF energy as it propagates through models of buildings and as it interacts with the models of the obstacles that exist in the real environment. The final outcome is a site-specific prediction of path loss, long-term fading, propagation delay, and the effects of the NLOS (Non-Line-Of-Sight) situation.

For outdoor channel modeling, a typical ray-tracing simulator will use the 3D building database data that is available for a particular area in order to predict certain features of the radio channel (such as the signal strength for cell planning). Although ray-tracing results in a more realistic radio channel model than does the use of an ‘off the shelf’ empirically based stochastic model, it is important to note that we can only import a limited level of detail into the simulation environment. Hence, building wall may be modeled as a panel without windows, light posts (which commonly act as scatterers) may not be included in the building database information, and vegetation cannot be exactly modeled. The omission of these and other details from the radio environment imply that the ray-traced channel model will primarily capture the phenomena of line of sight propagation, specular reflection, and corner diffraction, since the level of detail and the simulation time that would be required to completely model the effect of scattering on the radio signal would be prohibitive.

Since ray-tracing does not generally calculate the diffused rays, a new methodology is provided for channel prediction whereby ray tracing is used in order to predict the specular components of the multipath impulse response and then a stochastic model based on the CoDiT (Code Division Testbed) model is used in order to create the random phases and angles of arrivals of the diffused rays. These diffused rays will contribute to the short-term fading and the Doppler shift in the channel model. This approach will serve to elevate the ray-traced channel model to an even more realistic representation of the energy propagation in each specific area.

In these and other aspects, therefore, apparatus, and an associated method, is provided for facilitating emulation of a radio channel formed between a sending station and a receiving station. The receiving station is positioned at a selected reception location. A channel impulse response estimator is adapted to receive communication indicia associated with the radio channel. The channel impulse response estimator forms an estimate of a channel impulse response of the radio channel. The channel impulse response estimate is formed of a combination of at least a first non-diffuse component and at least a first diffuse component.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a representation of an urban propagation environment in which a radio channel is definable and a model of which is formable by the radio channel emulator of an embodiment of the present invention.

FIG. 2 illustrates a representation of short-term fading due to multi-path transmission, modeling of which is formable by the radio channel emulator of an embodiment of the present invention.

FIG. 3 illustrates a functional block diagram of a radio channel emulator of an embodiment of the present invention.

FIG. 4 illustrates a functional block diagram of a tap delay line model that forms part of the radio channel emulator shown in FIG. 3.

FIG. 5 illustrates an exemplary power delay profile formed by ray-tracing modeling, formed pursuant to operation of an embodiment of the present invention.

FIG. 6 illustrates a method flow diagram representative of operation of an embodiment of the present invention.

### DETAILED DESCRIPTION

While the use and implementation of particular embodiments of the present invention are presented in detail below, it will be understood that the present invention provides many inventive concepts which can be embodied in a wide variety of contexts. The specific embodiments discussed herein are mere illustrations of specific ways for making and using the invention and are not intended to limit the scope of the invention.

One method for generating site-specific channel models is through the use of ray tracing, by which one can simulate the behavior of RF energy as it propagates through models of buildings and as it interacts with the models of the obstacles that exist in the real environment. The final outcome is a site-specific prediction of path loss, long-term fading, propagation delay, and the effects of the NLOS (Non-Line-Of-Sight) situation.

For outdoor channel modeling, a typical ray-tracing simulator will use 3D building database data for a particular location in order to predict certain features of the radio channel, such as the signal strength for cell planning. Although ray-tracing results in a more realistic radio channel model than does the use of an ‘off the shelf’ empirically based stochastic model, it is important to note that only a limited level of detail is imported into the simulation environment. Hence, building wall may be modeled as a panel without windows, light posts, which commonly act as scatterers, may not be included in the building database information, and vegetation cannot be exactly modeled. The omission of these, and other, details from the radio environment imply that the ray-traced channel model will primarily capture the phenomena of line of sight propagation, specular reflection, and corner diffraction, since the level of detail and the simulation time that would be required to completely model the effect of scattering on the radio signal would be prohibitive. The detailed ray-tracing sensitivity analyses related to simulation time and predicted signal error are listed in.

Since ray-tracing does not generally calculate the diffused rays, we propose a new methodology for channel prediction whereby ray tracing is used in order to predict the specular components of the multipath impulse response and then a stochastic model based on CoDiT (Code Division Testbed) is used in order to create the random phases and angles of arrival of the diffused rays. These diffused rays will contribute to the short-term fading and the Doppler shift in the channel model. This approach serves to elevate the ray-traced channel model to an even more realistic representation of the energy propagation in each specific area. In the exposition to follow, a manner is provided by which to build the geo-location channel model, which combines both ray tracing and the stochastic models from CoDiT.

Geo-Location Channel Modeling Algorithm:

A channel prediction tool is provided that is based on the combined use of ray-tracing and stochastic modeling. The objective is to design a site-specific radio channel emulator that can closely represent the propagation channel experienced by the mobile terminal as a function of location. In order to achieve this criterion, the emulator design has to carefully consider several important propagation factors—such as path loss, long-term fading, the NLOS situation, short-term multipath fading and Doppler shift.

FIG. 1 provides a general idea about the regions that contribute to long-term fading and short-term fading, and how ray tracing calculates the specular reflections. FIG. 1 illustrates an urban area at which a set of communication stations, communication stations 12 and 14, are positioned. The communication station 12 forms a sending station, and the communication station 14 forms a receiving station. The sending station 12 here is representative of a base station of a cellular communication system, and the communication station 14 is representative of a mobile station of the cellular communication station.

The urban area includes a plurality of building structures 16. The building structures alter communication of signals between the sending and receiving stations forming the base station and mobile station. Ground areas, represented by the ground 18, areas of semi-transmission characteristics, represented by the area 22, objects that cause scattering, indicated by the area 24, objects that cause diffraction, indicated by the diffractor 26, and objects that cause reflections, indicated by the reflector 28, also form parts of the urban environment. These elements also affect transmission of signals between the communication stations 12 and 14. In the exemplary environment shown in FIG. 1, the portion of the area positioned at the left (as shown) of the line 32 defines a long-term fading region. And, the area to the right (as shown) of the line 32 defines a short-term fading region.

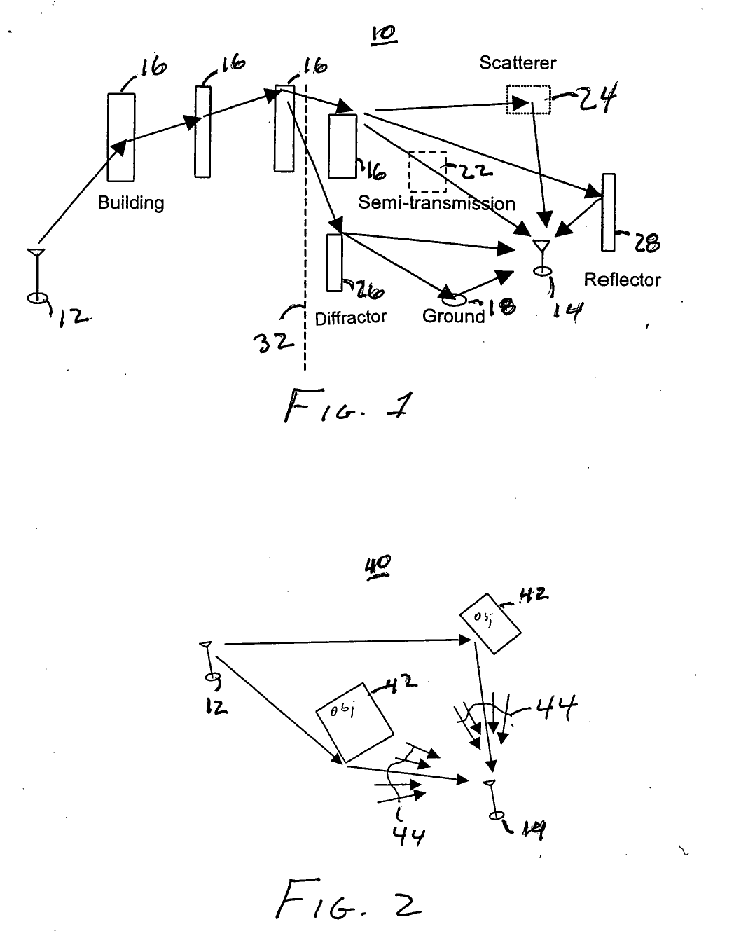

FIG. 2 illustrates another exemplary area, here shown generally at 40, also in which sending and receiving stations 12 and 14 are positioned. Here, objects 42 affects the communication of signals between the communication stations. Diffusers 44 also form part of the area 40 and cause diffusion of signals passing therethrough.

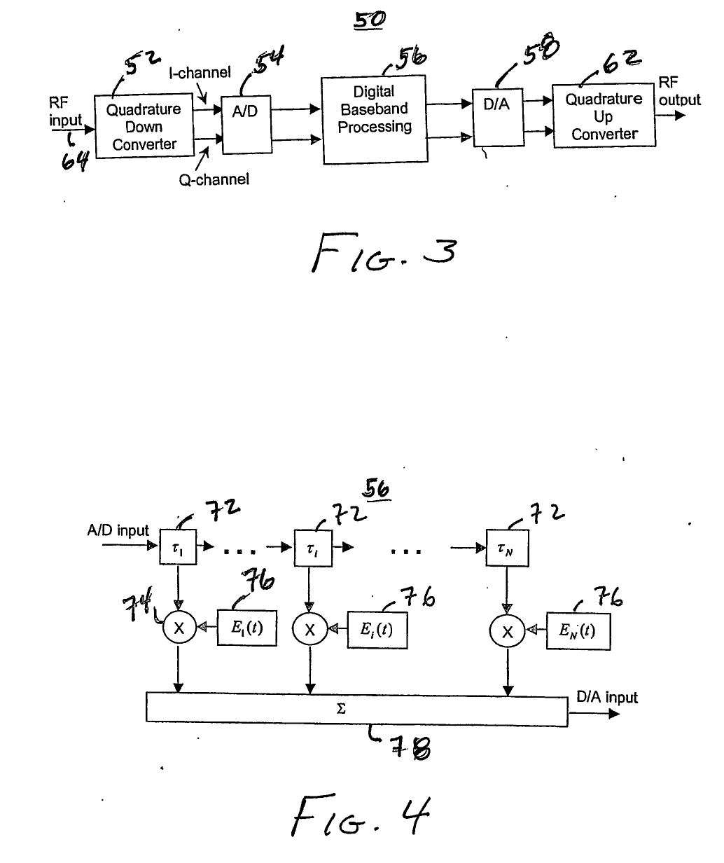

FIG. 3 illustrates a radio channel emulator, shown generally at 50, of an embodiment of the present invention. The emulator is used, in the exemplary implementation, pursuant to E-911 Phase II test environment procedures. The hardware-in-the-loop-E-911 phase II test environment is either a conducted environment or a radiated environment. Exemplary operation with respect to a radiated environment is described herein. Operation with respect to a conducted environment is analogous.

The emulator includes a quadrature down converter 52, an analog-to-digital (A/D) converter 54, a digital base band processing element 56, a digital-to-analog (D/A) converter 58, and a quadrature up converter 62.

The RF input from the transmitting antenna on the line 64 is first down converted to an IF (Intermediate Frequency) by the down converter 52 and then the system samples the incoming signal to perform an analog to digital (A/D) conversion by the converter 54. The outcome is the generation of an I-channel (in-phase component) and Q-channel (quadrature component). The Digital Baseband Processing element 56 is used to design and model the geo-location radio channel. Once the incoming IF is sampled and mixed with the specified I- and Q-channel impulse responses, then a digital to analog (D/A) conversion by the converter 58 will return the IF samples back to an IF analog signal. Finally, the IF analog signal is up converted to an RF signal output by the up converter. When the mobile receives this RF signal output from geo-location channel emulator, this RF signal generated from the emulator will be fairly representative of the RF signal that would be received during a field test.

A tapped delay line, as represented in FIG. 4, can be used to implement the Digital Baseband Processing block. The tapped delay line includes a plurality of delay elements 72 of which taps taken therefrom are mixed by mixers 74 with values 76. And, once mixed, the multiplied values are summed by a summer 78 for subsequent application to the D/A converter 58 (shown in FIG. 3). The i^{th} path delay bin of the multipath profile is represented as τᵢ. Multiple rays that arrive within the same bin are vector-summed (since they are expressed using complex components) and represented as Eᵢ(t) where i=1,2, . . . , N (e.g., N=10).

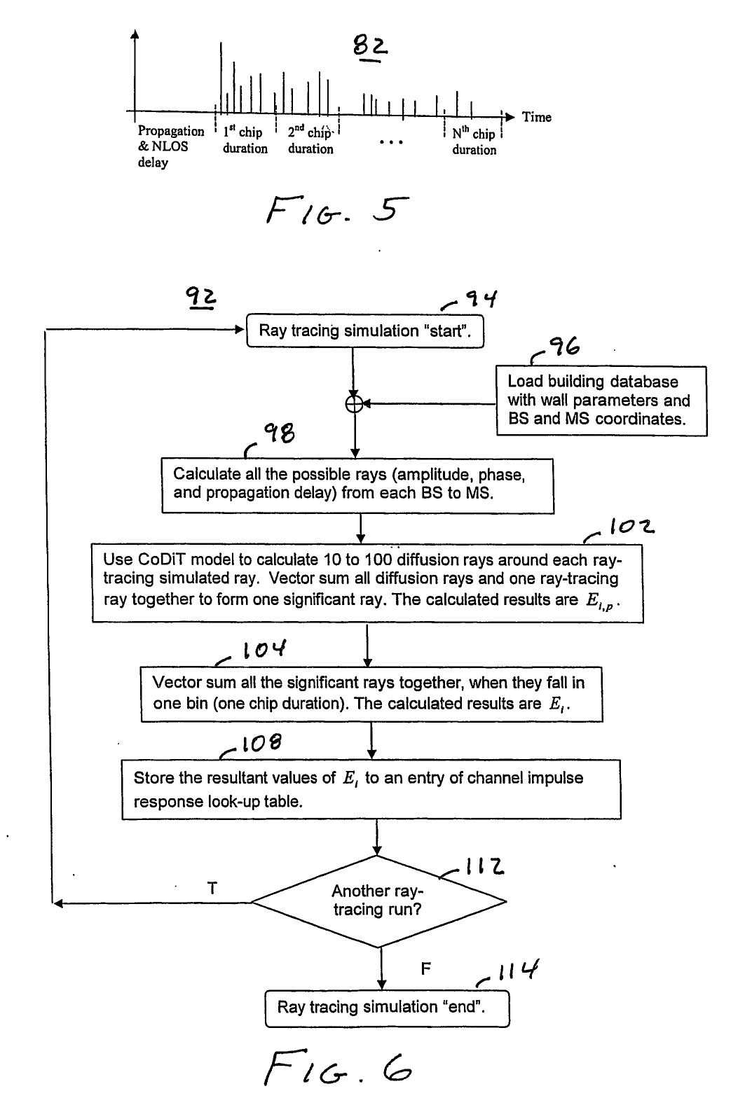

A typical example of the received power delay profile, shown generally at 82, generated from a ray-tracing simulation is shown in FIG. 5. In order to reduce the computation time, one must typically select the maximum allowed number of ray bounces (i.e., diffractions and reflections) to prune the ray-tracing tree-nodes complexity. Any ray that bounces more than the maximum allowed number is not considered further, since its received power level will be lower than a pre-specified threshold. In the exemplary implementation, a ray path is cut off after two reflections and three diffractions.

The channel impulse response based on this complex FIR filter implementation will be

$$\begin{matrix}h ( t , τ ) = {\sum }_{i = 1}^{N} {E}_{i} ( t ) \cdot δ ( τ - {τ}_{i} ) \\ and & ( 1 ) \\ {E}_{i} ( t ) = {\sum }_{p = 1}^{L} {E}_{i , p} ( t ) & ( 2 )\end{matrix}$$

where L is the number of ray-tracing rays fall into any one delay bin. E_{i,p}(t) is the complex field at time t, which is a combination of any one ray obtained from ray-tracing simulation and its associated diffusion rays, as shown in FIG. 2. This complex field including path loss, long-term fading, NLOS situation, short-term fading, and Doppler shift effect is given as

$${E}_{i , p} ( t ) = {A}_{i , p , 0} exp [ j ( {ϕ}_{i , p , 0} + \frac{2 π}{λ} v t cos {α}_{i , p , 0} ) ] + {\sum }_{k = 1}^{M} {A}_{i , p , k} exp [ j ( {ϕ}_{i , p , k} + \frac{2 π}{λ} v t cos {α}_{i , p , k} ) ] \qquad ( 3 )$$

where ν is the mobile speed and λ is the wavelength of the radio carrier frequency. M is the number of diffusion rays (e.g., M=10−100). A_{i,p,0} is the amplitude of the ray-tracing generated ray, such as LOS transmission ray, spectral reflection ray, main diffraction ray, and main scattering ray to the receiver. A_{i,p,k} is the amplitude of each diffusion ray around the ray-tracing generated ray. φ_{i,p,0} is the initial phase of the ray-tracing generated ray component and φ_{i,p,k} is the initial phase of the diffusion ray. α_{i,p,0} is the incident angle from the ray-tracing generated ray with respect to the mobile route in radians and α_{i,p,k} is the incident angle of the diffusion ray in radians.

The first term of Equation 3 represents the amplitude of each ray calculated from the ray-tracing simulation. Since ray-tracing calculations account for LOS and NLOS path loss, long-term fading, angle of arrival, and initial phase for each determinate ray, we consider these to be the deterministic parameter set. However, since the diffusion rays are not calculated by ray-tracing simulation due to the computation complexity and the diffusive propagation uncertainty, a CoDiT statistical channel model concept is used that enables modeling of short-term fading characteristics caused by spatial scatterers or the diffusion waves before the signals reach the receiver. These diffused waves shown in FIG. 2 are modeled by the second term of Equation 3. Assume the total received signal amplitude from each ray-tracing ray and its associated diffusion rays is a random variable which is defined as:
r_{i,p}=A_{i,p,k} k=0, 1, . . . , M (4)
The Nakagami m-distribution is used to describe the signal envelope, which is given by

$${f}_{{R}_{i , p}} ( {r}_{i , p} ) = \frac{2}{Γ ( {m}_{i , p} )} {( \frac{{m}_{i , p}}{{Ω}_{i , p}} )}^{m} {( {r}_{i , p} )}^{2 m - 1} exp ( - \frac{{m}_{i , p}}{{Ω}_{i , p}} {r}_{i , p}^{2} ) \qquad ( 5 )$$

where R_{i,p} is a set of random variables

$$\begin{matrix}{Ω}_{i , p} = E \{ {R}_{i , p} \} & ( 6 ) \\ {m}_{i , p} = \frac{{Ω}_{i , p}^{2}}{E \{ {( {R}_{i , p}^{2} - Ω )}^{2} \}} {m}_{i , p} \geq \frac{1}{2} & ( 7 )\end{matrix}$$

The Nakagami m-distribution is, in general, fairly representative of the distribution of any ray-tracing generated ray and its associated diffused rays. As m_{i,p} increases, the fading will be less severe and more Rician distributed. As a special case, Nakagami m-distribution becomes Rayleigh with m_{i,p}=1 and is a close approximation to the Ricean distribution for m_{i,p}>>1.

Since the Nakagami m-distribution is dependent on the values of m_{i,p} and Ω_{i,p}, it is important to note that the mean energy value of Ω_{i,p} can be obtained from the results obtained from the ray-tracing simulation. However, the value of m_{i,p} based on the CoDiT model is used, since the ray-tracing simulator does not model it. In general, the value of m_{i,p} is related to the wall surface roughness and building structure irregularity. For example, one can choose m_{i,p}=15 for the short-term propagation conditions or use this value as the mean value of a (truncated) Gaussian random variable to randomly select a m_{i,p}. If LOS situation is obtained between BS and MS, one can choose m_{i,p}=30. Thus, the values of A_{i,p,k} (where k=0, 1, . . . , M) can be calculated with the following three constraints.

$$\begin{matrix}E \{ {A}_{i , p , k} \} = 0 & ( 8 ) \\ E \{ {A}_{i , p , k}^{2} \} = \frac{{Ω}_{i , p}}{M} ( 1 - \sqrt{1 - {r}_{i , p}^{- 1}} ) & ( 9 ) \\ {A}_{i , p , 0} = \sqrt{{Ω}_{i , p} \sqrt{1 - {m}_{i , p}^{- 1}} )} & ( 10 )\end{matrix}$$

The second term in Equation 3 can be solved by selecting φ_{i,p,k} from the uniform distribution over [π,−π], so that the superposition of these partial waves corresponds to diffision interferences. The incident angles α_{i,p,k} are taken from a truncated Gaussian distribution with mean value α_{i,p,0} and standard deviation s=0.15 rad (=8.59°). The incident angle of α_{i,p,0}, the initial phase of φ_{i,p,0}, and the amplitude of A_{i,p,0} in the first term of Equation 3, are exactly determined from the ray-tracing simulation.

The simulated result of E_{i,p}(t) within one time bin (e.g., a chip duration is around 0.8 us for AFLT) will be vector-summed (i.e., complex-component summed) together to produce the complex amplitude of Eᵢ(t) which will be pre-processed by ray-tracing simulator and saved the ray-tracing simulation result as a single entry in a look-up table.

FIG. 6 illustrates a flow diagram, shown generally at 92, that generates the pre-processed channel impulse response of Eᵢ₍ₜ₎. Operations start at the block 94 at the ray tracing simulation start. A building database is loaded with wall parameters and base station and mobile station coordinates, as indicated at the block 96. Then, and as indicated by the block 98, all of the possible rays from each base station to the mobile station are calculated. The rays are represented in terms of amplitude, phase, and propagation delay.

Then, and as indicated by the block 102, CoDiT modeling is used to calculate ten to one hundred diffusion rays around each ray tracings simulated ray calculated at the operation 98. And, all of the diffusion rays are vector summed together, and one ray-tracing ray together forms one significant ray. The calculated results are Eᵢₚ.

Then, at the block 104, all of the significant rays are vector summed together when within a single chip duration (shown in FIG. 5). The calculated results define Eᵢ. Thereafter, and as indicated by the block 108, the resultant values are stored to an entry of a channel impulse channel look-up table.

Thereafter, a decision is made, indicated by the decision block 112, as to whether to perform another ray-tracing run. If so, the T branch is taken back to the block 94. Otherwise, a branch is taken to the N block 114.

Then, this look-up table will be stored in the computer DRAM for real-time emulation of the propagation channel. Each entry of this looked-up table represents one propagation channel for a specified MS (mobile station) and BS (base station) coordinate pair, and for the particular building locations and structures modeled from the environment. When we run this geo-location propagation channel emulator as in FIG. 1, this pre-processed entry of looked-up table will feed into a tapped-delay-line model in real-time, which is shown in FIG. 4.

While this invention has been described with reference to particular embodiments, this description is not intended to be limiting. Various modifications and combinations of the illustrative embodiments, as well as other embodiments of the invention, will be apparent to persons skilled in the art. It is, therefore, intended that the appended claims encompass any such modifications or embodiments.

1. Apparatus for facilitating emulation of a radio channel formed between a sending station and a receiving station, the receiving station positioned at a selected reception location, said apparatus comprising:
a channel impulse response estimator adapted to receive communication indicia associated with the radio channel, said channel impulse response estimator for forming an estimate of a channel impulse response of the radio channel, the channel impulse response estimate formed of a combination of at least a first non-diffuse component and at least a first diffuse component.

2. The apparatus of claim 1 further comprising a signal applicator, said signal applicator for applying an application signal to said channel impulse response estimator, the application signal representative of a send signal sent by the sending station to the receiving station upon the radio channel.

3. The apparatus of claim 2 further comprising a signal detector adapted to receive indications of the application signal, subsequent to application to said channel impulse response estimator, the application signal representative of the send signal, sent upon the radio channel and delivered to the receiving station.

4. The apparatus of claim 1 wherein the communication indicia to which said channel impulse response estimator is adapted to receive comprise communication path parameter indicia.

5. The apparatus of claim 4 wherein the estimate of the channel formed by said channel impulse response estimator comprises a multipath profile estimative of the radio channel.

6. The apparatus of claim 5 wherein the multipath profile forming the estimate of the channel formed by said channel impulse response estimator comprises a first path and at least a second path, the second path delayed by at least a first selected delay period.

7. The apparatus of claim 6 wherein the first and at least second paths of the multipath profile forming the estimate of the channel defined by said channel impulse response estimator each comprise non-diffuse components.

8. The apparatus of claim 7 wherein the first path of the multipath profile comprises the first non-diffuse component and wherein the second path of the multipath profile comprises a second non-diffuse component.

9. The apparatus of claim 8 wherein the first path of the multipath profile comprises the first diffuse component and wherein the second path of the multipath profile comprises a second diffuse component.

10. The apparatus of claim 1 wherein the first diffuse component of which the channel impulse response estimate is formed comprises a representation of a combination of diffusely-propagated parts, propagated responsive to propagation of the first non-diffuse component.

11. The apparatus of claim 1 wherein the sending station comprises a first sending station and a second sending station, wherein the radio channel comprises a first radio channel part and a second radio channel part, the first radio channel part extending between the first sending station and the receiving station and the second radio channel part extending between the second sending station and the receiving station, the estimate formed by said channel impulse response estimator of both the first and second radio channel parts.

12. The apparatus of claim 1 wherein the first diffuse component comprises a statistical representation.

13. A method for facilitating emulation of a radio channel formed between a sending station and receiving station positioned at a selected reception location, said method comprising the operations of:
forming an estimate of a channel impulse response of the radio channel responsive to communication indicia associated with the radio channel, the estimate of the channel impulse response formed of a combination of at least a first non-diffuse component and at least a first diffuse component; and
using the estimate to emulate the radio channel.

14. The method of claim 13 wherein said operation of forming comprises forming a multipath profile estimative of the radio channel.

15. The method of claim 14 wherein the multipath profile formed during said operation of estimating comprises a first path and at least a second path, the second path delayed by at least a first selected delay period.

16. The method of claim 15 wherein the first and at least second paths formed during said operation of forming the multipath profile each comprise non-diffuse components.

17. The method of claim 16 wherein the first and at least second paths formed during said operation of forming the multipath profile each comprise diffuse components.

18. The method of claim 13 wherein the at least first diffuse component of which the estimate of the channel impulse is, in combination, formed during said operation of forming is based upon a statistical representation.

19. The method of claim 13 further comprising an operation of applying send signals to the estimate formed during said operation.

20. The method of claim 19 further comprising the operation of positioning the receiving station to receive the send signal, once applied to the estimate formed during said operation of forming, and performing link trilateration operations at the receiving station.
